(19) United States
(12) Patent Application Publication
(10) Pub. No.: US 2005/0230446 A1
(43) Pub. Date: Oct. 20, 2005

(54) Tape dispenser device which neutralizes a static charge from the tape and method therefor

(76) Inventor: Paul E. Weiss, Mesa, AZ (US)

Correspondence Address: WEISS & MOY PC, 4204 NORTH BROWN AVENUE, SCOTTSDALE, AZ, 85251, US

(21) Appl. No.: 10/827,091

(22) Filed: Apr. 19, 2004

(51) Int. Cl. B26F 3/02

(52) U.S. Cl. 225/6; 225/33

(57) ABSTRACT

A tape dispensing device is able to neutralize a static charge on a piece of tape so that the tape will not curl up and become tangled. The tape dispensing device has a body member which houses a roll of tape. A cutting device is coupled to one end of the body member for cutting a piece of tape from the roll of tape. A neutralizing device is coupled to the body member and next to the cutting device for neutralizing a static charge from the piece of tape.

### BACKGROUND OF THE INVENTION

1. Field of the Invention

This invention relates to office supplies and, more specifically, to a tape dispenser which has a device for neutralizing the static charge from the tape thereby preventing the tape from becoming tangled when removed from the tape dispenser.

2. Description of the Prior Art

Tape dispensing devices have been around for many years. A typical tape dispensing device has a body section for holding a roll of tape. A cutting device is positioned on one end of the body section. The cutting device is used for cutting the tape once the desired length of tape has been dispensed.

The main problem most tape dispensing devices have is with static electricity. When a person dispenses a piece of tape from the tape dispenser, the tape has a tendency to curl up after the tape has been cut. The curling of the tape is due to static electricity. The static charge on the tape generally causes one end of the tape to curl up and to stick to other parts of the piece of tape which has been dispensed. Many times it is difficult to separate the tape once the tape curls up and gets tangled.

Therefore, there is a need for an improved tape dispensing device. The improved tape dispensing device would eliminate the problems associated with prior art devices. The improved tape dispensing device will neutralize the static electricity from the dispensed tape thereby preventing the tape from curling up and becoming tangled.

### SUMMARY OF THE INVENTION

In accordance with one embodiment of the present invention, it is an object of the present invention to provide an improved tape dispensing device.

It is another object of the present invention to provide an improved tape dispensing device that would eliminate the problems associated with prior art devices.

It is another object of the present invention to provide an improved tape dispensing device that will neutralize the static electricity from the dispensed tape.

It is still another object of the present invention to provide an improved tape dispensing device that will neutralize the static electricity from the dispensed tape thereby preventing the tape from curling up and becoming tangled.

### BRIEF DESCRIPTION OF THE EMBODIMENTS

In accordance with one embodiment of the present invention a tape dispensing device is disclosed. The tape dispensing device has a body member which houses a roll of tape. A cutting device is coupled to one end of the body member for cutting a piece of tape from the roll of tape. A neutralizing device is coupled to the body member and next to the cutting device for neutralizing a static charge from the piece of tape.

In accordance with another embodiment of the present invention, a device for removing a static charge from tape is disclosed. The device has a base plate which is coupled to a tape dispensing device. A channeling is formed in the base plate wherein the channeling allows the tape to be pulled through the channeling. A cutting surface is coupled to an edge of the channeling. A neutralizing device is coupled to the base plate and next to the cutting surface for neutralizing a static charge from the tape.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is an elevated perspective view of a tape dispensing device of the present invention.

FIG. 2 is a magnified view of the static charge removing portion of the tape dispensing device of the present invention.

FIG. 3 is another magnified view of the static charge removing portion of the tape dispensing device of the present invention.

### DETAILED DESCRIPTION OF THE PREFERRED EMBODIMENT

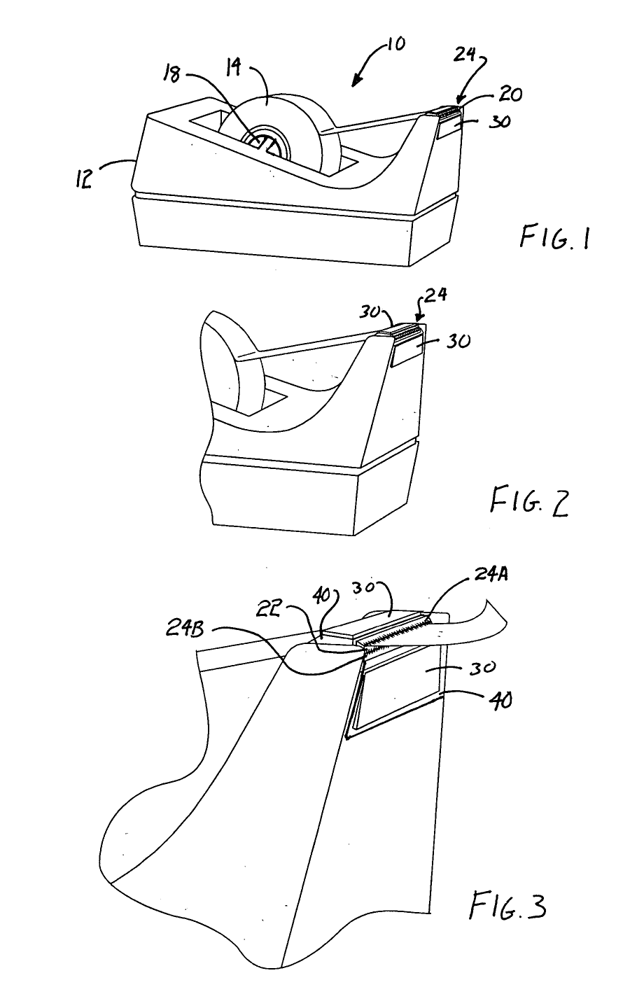

Referring to FIGS. 1-3, a tape dispensing device 10 is shown. The tape dispensing device 10 is able to neutralize the static charge on the tape that is being dispensed thereby preventing the tape from curling up and becoming tangled.

The tape dispensing device 10 has a body member 12. The body member 12 is used for holding a roll of tape 14 which is being dispensed. The size and shape of the body member 12 is not important. All that is necessary is for the body member 12 to firmly hold the roll of tape 14 in place when the roll of tape is being dispensed. In accordance with one embodiment of the present invention, the body member 12 is formed as an “L” shaped block. A cavity 16 is formed in the interior side of the body member 12. The cavity 16 is used to secure the roll of tape 14 within the cavity 16 while allowing the roll of tape 14 to rotate while dispensing the tape. In general, a holding mechanism 18 is used to secure the roll of tape 14 within the cavity 16 while allowing the roll of tape 14 to rotate within the cavity 16. In the embodiment depicted in FIG. 1, a rod member is used as the holding mechanism 18.

A cutting device 20 is coupled to one end of the body member 12. The cutting device 20 is used to cut the tape once the desired length of tape has been dispensed from the roll of tape 14. In the embodiment depicted in the Figures, the cutting device 20 is coupled to the distal end of the leg of the “L” shape body member 12. The cutting device 20 may be a single or dual sided cutting device 20. Thus, the cutting device 20 may be designed to cut in a single direction or in two directions.

In the embodiment depicted in the Figures, the cutting device 20 is a dual sided cutting device 20. The cutting device 20 comprises a channeling 22 through which the tape is inserted. The channeling 22 will have a pair of cutting surfaces 24. A first cutting surface 24A is located on a lower edge of the channeling 22. This will allow one to cut the tape by pulling the tape in a downward manner. A second cutting surface 24B is located on an upper edge of the channeling 22. This will allow one to cut the tape by pulling the tape in an upward manner.

In order to neutralize the static charge on the tape that is being dispensed, a neutralizing mechanism 30 is coupled to the body member 12. The neutralizing mechanism 30 should be coupled near the cutting device 20. Thus, as the tape is being pulled through the cutting device 20, the tape will be in close enough proximity to the neutralizing mechanism 30 such that the neutralizing mechanism 30 will neutralize any static charge on the tape. Once the tape is cut, the tape will not roll up since the static charge has been neutralized. In the embodiment depicted in the Figures, the neutralizing mechanism 30 is coupled near a top and bottom surface of the cutting device 20. Thus, whether one pulls the tape in an upward or downward manner, one of the neutralizing mechanisms 30 will neutralize any static charge on the tape. In accordance with one embodiment of the present invention, the neutralizing mechanism 30 is a magnet.

It should be noted that the cutting mechanism 20 and the neutralizing mechanism 30 may be formed as a single unit. The single unit may be formed so that the single unit may be placed on any existing tape dispenser currently being sold. The single unit would have a base plate 40. The base plate 40 would be an angled base plate 40 which would fit on the end of the leg portion of the “L” shape body member 12. Some type of adhesive would be provided to couple the base plate 40 to the existing tape dispenser.

The cutting device 20 is formed on the base plate 40. The channeling 22 of the cutting device 20 is formed in the base plate 40 to allow the tape to be pulled through the base plate 40. The cutting surface 24 is formed on at least one edge of the channeling 22. In the embodiment depicted in the Figures, the first cutting surface 24A is located on the lower edge of the channeling 22. This will allow one to cut the tape by pulling the tape in a downward manner. The second cutting surface 24B is located on the upper edge of the channeling 22. This will allow one to cut the tape by pulling the tape in an upward manner.

The neutralizing mechanism 30 is coupled to the base plate 40 near the cutting surfaces 24. Thus, as the tape is being pulled through the channeling 22, the neutralizing mechanism 30 will neutralize any static charge on the tape. Once the tape is cut, the tape will not roll up since the static charge has been neutralized. In the embodiment depicted in the Figures, the neutralizing mechanism 30 is coupled near the first cutting surface 24A and the second cutting surface 24B. Thus, whether one pulls the tape in an upward or downward manner, one of the neutralizing mechanisms 30 will neutralize any static charge on the tape.

While the invention has been particularly shown and described with reference to preferred embodiments thereof, it will be understood by those skilled in the art that the foregoing and other changes in form and details may be made therein without departing from the spirit and scope of the invention.

1. A tape dispensing device comprising:
a body member which houses a roll of tape;
a cutting device coupled to one end of the body member for cutting a piece of tape from the roll of tape; and
a neutralizing device coupled to the body member and next to the cutting device for neutralize a static charge from the piece of tape.

2. A tape dispensing device in accordance with claim 1 wherein the body member comprises:
an “L” shaped base;
a cavity formed in an interior section of the “L” shaped base; and
a holding mechanism for holding the roll of tape in the cavity while allowing the roll of tape to rotate when tape is being dispensed.

3. A tape dispensing device in accordance with claim 1 wherein the cutting device is a dual direction cutting device.

4. A tape dispensing device in accordance with claim 3 wherein the dual direction cutting device comprises:
a channeling having an opening which allows the tape to pass through;
a first cutting surface located on a bottom edge of the channeling; and
a second cutting surface located on a top edge of the channeling.

5. A tape dispensing device in accordance with claim 1 wherein the neutralizing device is a magnet.

6. A tape dispensing device in accordance with claim 4 wherein the neutralizing device comprises:
a first magnet coupled to the body member and next to the first cutting surface; and
a second magnet coupled to the body member and next to the second cutting surface.

7. A tape dispensing device comprising:
a body member which houses a roll of tape;
a dual direction cutting device coupled to one end of the body member for cutting a piece of tape from the roll of tape, the dual direction cutting device comprising:
a channeling having an opening which allows the tape to pass through;
a first cutting surface located on a bottom edge of the channeling; and
a second cutting surface located on a top edge of the channeling;
a neutralizing device coupled to the body member and next to the cutting device for neutralizing a static charge from the piece of tape.

8. A tape dispensing device in accordance with claim 7 wherein the body member comprises:
an “L” shaped base;
a cavity formed in an interior section of the “L” shaped base; and
a holding mechanism for holding the roll of tape in the cavity while allowing the roll of tape to rotate when tape is being dispensed.

9. A tape dispensing device in accordance with claim 7 wherein the neutralizing device comprises:
a first magnet coupled to the body member and next to the first cutting surface; and
a second magnet coupled to the body member and next to the second cutting surface.

10. (canceled)

11. (canceled)

12. (canceled)

13. (canceled)

14. A tape dispensing device comprising:
a body member which houses a roll of tape;
a cutting device coupled to one end of the body member for cutting a piece of tape from the roll of tape; and
means for neutralizing a static charge from the piece of tape coupled to the body member and next to the cutting device.

15. A tape dispensing device in accordance with claim 14 wherein the body member comprises:
an “L” shaped base;
a cavity formed in an interior section of the “L” shaped
a holding mechanism for holding the roll of tape in the cavity while allowing the roll of tape to rotate when tape is being dispensed.

16. A tape dispensing device in accordance with claim 14 wherein the cutting device is a dual direction cutting device.

17. A tape dispensing device in accordance with claim 16 wherein the dual direction cutting device comprises:
a channeling having an opening which allows the tape to pass through;
a first cutting surface located on a bottom edge of the channeling; and
a second cutting surface located on a top edge of the channeling.
